(19) United States
(12) Patent Application Publication
(10) Pub. No.: US 2026/0264122 A1
(43) Pub. Date: Sep. 10, 2026

(54) Autonomous Wellhead Monitoring And Pressure Adjusting System

(71) Applicant: R&M Systems, Inc., Grand Junction, CO (US)

(72) Inventors: Rikki Cook, Grand Junction, CO (US); Marc Fiot, Grand Junction, CO (US); Christian Fiot, Grand Junction, CO (US)

(21) Appl. No.: 19/542,290

(22) Filed: Feb. 17, 2026

Related U.S. Application Data
(60) Provisional application No. 63/759,117, filed on Feb. 15, 2025.

(51) Int. Cl. B09B 1/00; E21B 43/12; G05D 7/06

(52) U.S. Cl. CPC B09B 1/006; E21B 43/12; G05D 7/0635

(57) ABSTRACT

An apparatus for autonomous landfill gas monitoring and automation comprising a non-invasive assembly for wellhead optimization. A conformable valve adjuster is configured to engage a manual valve handle via mechanical interference to convert data-driven or user-initiated commands into physical valve modulations without impeding routine manual operation. The apparatus comprises modular components, including power and valve adjuster assemblies. The system further comprises a pneumatic conditioning assembly to protect internal components and condition gas samples. A communication interface enables two-way transmission of data and commands via a local mesh network and gateway node to a remote application. The apparatus utilizes control loop feedback and multivariate datasets to enable automated wellfield balancing and optimized gas extraction rates.

### CROSS REFERENCE TO RELATED APPLICATIONS

This application claims the benefit of US Provisional Application No. 63/759,117, titled “Continuous Landfill Gas Monitoring and Autonomous Wellhead Pressure Adjustment System” and filed on Feb. 15, 2025.

### FIELD OF THE INVENTION

The present invention relates generally to landfill monitoring systems and, more particularly, to automated systems and methods for the monitoring and control of the gas extraction processes.

### BACKGROUND OF THE INVENTION

Landfill gas is primarily produced through the anaerobic decomposition of organic materials within a waste mass. This process generates gas mixtures that commonly contain methane, carbon dioxide, and other gaseous constituents formed through methanogenesis and related biological pathways. Landfills are recognized as a significant source of methane emissions, and uncontrolled releases can present environmental, operational, and safety concerns.

Under federal air regulations, landfills 200 exceeding specific waste-in-place thresholds or emissions criteria must install gas collection and control systems 204. As referenced in FIG. 2, these systems include networks of vertical and horizontal extraction wells 101 installed within a waste mass 201. Generally, perforated sections of the wells are located within the waste mass 201 to serve as the interface for landfill gas 203 entry. Wellhead risers 206 extend from these sections through the soil cover 205 to the surface for operation and maintenance.

Conventional wellheads include a manual valve 209 to regulate vacuum and an orifice plate 207 to provide flow restriction. Well sampling ports 208 allow for gas composition and pressure monitoring via portable analyzers. Collected gas is routed to a flare 211 or processed at downstream beneficial use facilities 212, such as the generation of electricity, where gas composition and quantity is critical for facility performance.

The performance of gas collection and control system 204 is sensitive to changing conditions. Variations in atmospheric pressure, temperature, and weather patterns can alter the pressure gradients acting on an individual extraction well 101 or the entire wellfield. The area of the waste mass 201 impacted by the vacuum of a specific wellhead is referred to as the zone of influence 307. As illustrated in FIG. 3, the respective zone of influence 307 of neighboring wells within the wellfield should ideally align to create a continuous barrier against the escape of fugitive emissions 300. Excessive overlap between these zones can lead to too much vacuum 303, pulling air through the surface and causing oxygen intrusion 302, which increases the risk of subsurface fire 304. Conversely, failing to maintain an optimal vacuum 305 can result in not enough vacuum 301, allowing landfill gas 203 to bypass the well and escape as fugitive emissions 300.

Monitoring well conditions is typically performed during scheduled field visits using handheld instruments to measure methane, carbon dioxide, oxygen, temperature, and pressure. Because these measurements are obtained only at discrete intervals, operators have limited visibility into transient barometric disturbances, short-term instability, or gradual drift in system performance. Consequently, manual adjustments made during periodic rounds often fail to account for conditions occurring between visits, potentially compromising emission control, gas quality, and the safe operation of downstream systems.

### BRIEF SUMMARY OF THE INVENTION

Provided in this section is a general discussion of certain embodiments of the invention with references to certain features depicted in the drawings for non-limiting illustrative purposes only. In accordance with the present disclosure, the Autonomous Wellhead Monitoring & Adjusting System 100 provides non-invasive monitoring and continuous control for a landfill wellhead. The system 100 comprises a ruggedized enclosure 102 having an interior chamber configured with mounting brackets 404 to support a plurality of analytical and support modules. The enclosure 102 includes environmental management features to maintain optimal conditions for internal components and is supported by adjustable feet 104. In some configurations, to prevent unauthorized removal, the system 100 is releasably secured to a wellhead riser 206 via a tethering member 105 and includes integrated security and theft detection. The system 100 is configured for installation and operation without infrastructure modification, without cessation of vacuum pressure, or alterations to the gas flow.

In some embodiments such as shown in FIG. 6, the Autonomous Wellhead Monitoring and Pressure Adjusting System 100 comprises a pneumatic conditioning assembly (comprised of tubing 112, filtration 115, device selector 117, port adapter 601, hydrophobic filter 800, desiccant 801, and pressure relief valve 802) which fluidly couples the systems sample port 106 to the extraction well 101. Device selector 117 comprises a port adapter 601 that engages a well sampling port 208. The port adapter 601 allows the system to interface directly with the wellhead at sampling port(s) 208 for sampling of landfill gas 203. The device selector 117 comprises a manual diverter 600 configured to allow operators to selectively route landfill gas 203 either to monitor for autonomous operation 602 using the system 400 or to handheld monitor 603 for routine compliance reporting based on moving the manual diverter 600 to different positions. The selection of which position of the diverter 600, and consequently to where the landfill gas 203 is diverted, is performed without removing the assembly from the extraction well 101 or disconnecting the well sampling port 208. The pneumatic conditioning assembly may also include one or more serviceable modules for liquid separation and gas filtration 115, an example of which is a hydrophobic filter 800 and desiccant 801 as shown in FIG. 8 and described further herein. The device selector 117 may include or be comprised of (at least partially) an insulating material.

In some embodiments as shown in FIG. 4, a controller 400 houses a gas sensor array 703 and a pressure sensor suite 704 with analytical transducers. The controller 400 is configured for operation in explosive environments. The controller 400 is configured to execute an ambient air purge sequence between active sampling events, drawing air from an ambient port 108 to clear the gas sensor suite 703, which enhances sensor performance. Additionally, the controller 400 can transition to a high frequency sampling mode upon detection of anomalies.

In some embodiments as shown in FIG. 1 and FIG. 5, a non-invasive valve adjuster 116 assembly engages a manual wellhead valve 209 via mechanical interference. The non-invasive valve adjuster 116 may include a resilient, conforming interface configured to accommodate varying handle geometries without requiring modification to the extraction well 101. The locking mechanism 501 consists of inserts configured to lock the assembly in place, while a rotary drive member 502 is driven by a motor 500 to actuate the valve. The controller 400 is configured to execute a resistance learning routine to identify physical rotational limits and end stops by monitoring power usage changes to deduce torque.

In some embodiments, the controller 400 initiates an active gas sampling sequence based on one of three triggers: a change detected by passive transducers, expiration of a time interval, or a manual trigger command.

Final calibration and autonomous valve tuning logic are managed via a remote companion cloud application 905. The application utilizes a PID control loop incorporating a stabilization time constant and analyzes current data in view of historic performance trends. The remote companion cloud application 905 utilizes a weighted priority architecture to resolve conflicting sensor signals, prioritizing safety and regulatory compliance limits over gas quality optimization. To modulate a gas extraction rate, the application transmits movement commands to the controller 400, which drives the non-invasive valve adjuster 116 to rotate the manual wellhead valve 209.

In some embodiments, the assembly operates as a node, where the cloud application 905 enables synchronized adjustments across a plurality of nodes by managing the relationships between them. To optimize power consumption and transmission, any node can be dynamically reconfigured to function as a gateway node. The nodes are configured to route data packets 900 to a gateway node, which utilizes a communications 707 interface for transmission to the cloud application 905. The cloud application 905 executes neighbor-aware tuning logic, which is implemented by the controller 400 to drive the non-invasive valve adjuster 116. The controller 400 is configured for redundant data persistence via internal storage 706 to buffer sensor data 901 during communication outages.

These and other features of the invention are described in more detail below.

### BRIEF DESCRIPTION OF THE DRAWINGS

The following drawings are intended to be illustrative and not limiting the scope of the present disclosure. The drawings are not necessarily to scale, and certain features may be shown exaggerated in scale or in somewhat schematic form in the interest of clarity and conciseness. Various alterations, modifications, and improvements will readily occur to those skilled in the art, and the technology described herein is intended to encompass such variations. The specific embodiments illustrated are provided as examples of the broader concepts disclosed.

FIG. 1 is a system architecture diagram of an example non-invasive gas monitoring and control assembly in a deployed landfill environment, in accordance with some embodiments of the technology described herein.

FIG. 2 is a schematic diagram illustrating gas flow and regulation through a wellhead assembly within a landfill environment.

FIG. 3 is a schematic diagram illustrating operational inefficiencies and environmental hazards resulting from improper wellhead tuning in a landfill gas collection system.

FIG. 4 is a schematic diagram illustrating the internal layout of an enclosure containing analytical and support modules for a wellhead monitoring and adjustment system.

FIG. 5 is a perspective view of the non-invasive valve adjuster including a cutaway view illustrating the internal drive components for automated valve actuation.

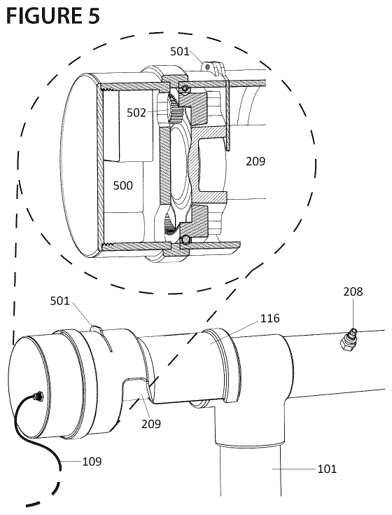

FIG. 6 is a schematic diagram illustrating a device selector in a first configuration for autonomous monitoring and a second configuration for manual sampling.

FIG. 7 is a schematic diagram illustrating the internal components of the controller.

FIG. 8 is a schematic diagram illustrating a gas sample pathway and conditioning path.

FIG. 9 is a flowchart illustrating a method for data transmission from a wellhead monitor to a cloud application.

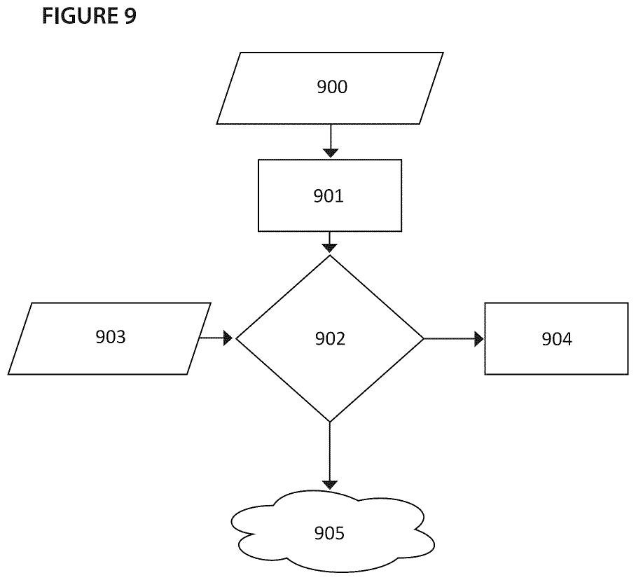

FIG. 10 is a schematic diagram illustrating a configuration of a cloud-based user application for monitoring and managing a field of gas extraction wells.

FIG. 11 is a schematic diagram illustrating a valve adjuster configuration that sleeves over the geometry to the wellhead valve.

### DETAILED DESCRIPTION

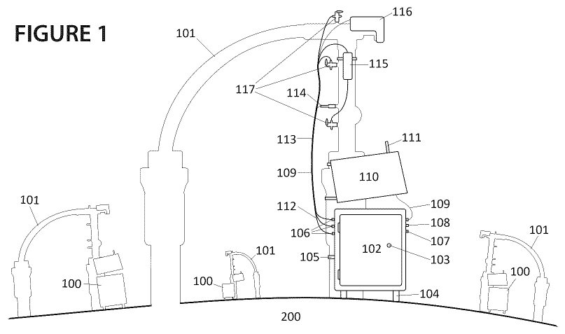

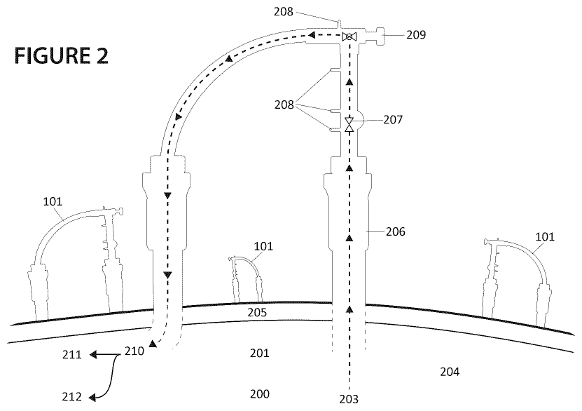

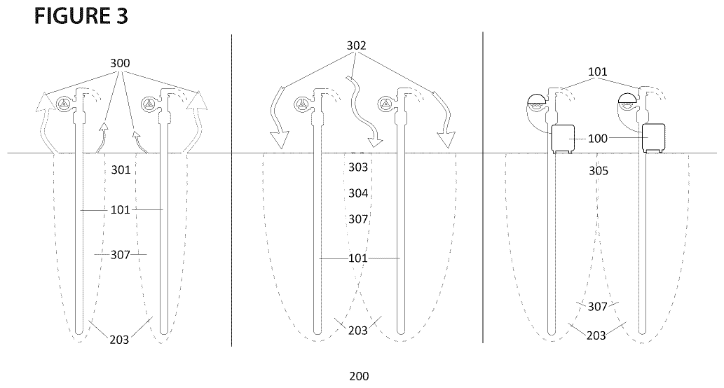

Embodiments of the invention provide an autonomous wellhead monitoring and pressure adjusting system 100 for non-invasive attachment to a landfill extraction well 101. Referring to FIG. 1, the autonomous wellhead monitoring and pressure adjusting system 100 enables real-time modulation of vacuum pressure to maintain target gas compositions without infrastructure modification or operational downtime. By executing autonomous tuning based on continuous sampling, the autonomous wellhead monitoring & adjusting system 100 utilizes a non-invasive valve adjuster 116 to dynamically vary the gas extraction rate. This physical modulation is configured to mitigate fugitive emissions 300 and inhibit oxygen intrusion 302, as illustrated in FIG. 3, which supports regulatory safety and enhances operational performance by stabilizing the gas collection environment. As shown in FIG. 2, this mechanical interface transforms legacy manual wellheads into autonomous networked nodes without requiring the cessation of vacuum pressure or physical alteration of the extraction well 101.

### Operational Environment

Referring now to FIG. 2, there is shown a schematic representation of the operational environment for a gas monitoring and control assembly. The landfill 200 generally comprises a waste mass 201 disposed beneath a landfill soil cover 205. Landfill gas 203, typically comprising a mixture of methane, carbon dioxide, and various trace gases, is extracted from the waste mass 201 via a plurality of extraction wells 101, which form a component of a larger gas collection and control system 204. Each extraction well 101 is fluidly coupled to a vacuum source 210, which provides the necessary pressure gradient to induce flow of the landfill gas 203 through the system. The infrastructure is configured to manage liquid condensate to mitigate flow resistance within the system. The collected gas is subsequently routed for monitoring, destruction via a flare 211, delivery to a downstream beneficial use facility 212, or other processing infrastructure.

As further illustrated in FIG. 2, the interface for gas regulation at each extraction well 101 typically includes a manual wellhead valve 209 and an orifice plate 207 for measuring flow characteristics. The manual wellhead valve 209 serves as the primary mechanical control for adjusting the vacuum applied to the waste mass 201. In conventional operations, adjustments to this manual wellhead valve 209 require physical presence and manual labor, a process that the present monitoring and control assembly is configured to automate through a non-invasive interface.

A significant technical advantage of the autonomous wellhead monitoring and pressure adjusting system 100 is its non-invasive deployment methodology, which preserves landfill operational uptime. The system 100 and its associated components are designed for installation on existing wellhead infrastructure without requiring a cessation of the gas collection and control system 204. Furthermore, the modular deployment and secure tethering to the wellhead riser 206 via a tethering member 105 eliminate the need for penetrations of the landfill soil cover 205. By maintaining the physical integrity of the landfill soil cover 205 and the continuity of the vacuum source 210, the system 100 prevents environmental risks associated with gas collection and control system 204 downtime or surface layer disruption.

### System Architecture

Referring now to FIG. 1, the autonomous wellhead monitoring and pressure adjusting system 100 is primarily contained within a secure, hardened enclosure 102. In at least one embodiment, the enclosure 102 comprises a high durability stainless steel structure specifically engineered to resist theft, mechanical impact, wildlife, and unauthorized tampering in unmanned landfill environments. To provide additional security, the enclosure 102 may include a lock 103. To elevate the electronic and pneumatic components from ground level hazards including pooling liquid, soil based corrosion, or debris, the enclosure 102 is provided with a plurality of adjustable feet 104. These adjustable feet 104 facilitate level deployment on the uneven, settling terrain typical of a landfill 200 surface. For enhanced physical security, the assembly is secured to fixed infrastructure, such as the wellhead riser 206, via a high tensile strength tethering member 105. The tethering member 105 may comprise galvanized aircraft cable, heavy duty metallic chain, or similar tamper resistant materials.

Internally, the enclosure 102 is configured for modularity and ease of maintenance. A mounting interface, such as a mounting bracket 404, is disposed along the interior rear wall to support a plurality of removable modules, which may include but are not limited to a controller 400, a calibration module 406, and a battery module 402. A desiccant filter 403 is also contained within the enclosure 102 to manage internal moisture and protect sensitive electronics. The power source comprises an energy storage device, such as an intrinsically safe high capacity battery module 402, in operable communication with an external power input interface via the electrical cable harness 109. In one embodiment, the external power input interface is coupled to a regenerative source, such as a pivoting solar panel assembly 110. In alternative embodiments, the power input interface is configured to receive electrical power from a fixed external source, facilitating operation of the assembly without a pivoting solar panel assembly 110.

### Solar Powered

In configurations utilizing a pivoting solar panel assembly 110, the panel is supported by an adjustable mounting assembly. This pivoting solar panel assembly 110 is configured to facilitate the physical orientation of the solar panel toward the sun to maximize solar irradiance across varying latitudes and seasonal cycles. The orientation is achieved by rotating the entire pivoting solar panel assembly 110 and tilting the panel to provide optimal positioning. The pivoting solar panel assembly 110 is configured for direct attachment to the enclosure 102, or in alternative configurations, for attachment to nearby fixed infrastructure such as a wellhead riser 206 or a dedicated support post.

In some embodiments, the apparatus further comprises an energy storage means, such as a thermally resilient battery module 402, configured to store electrical energy generated by the pivoting solar panel assembly 110. The energy storage means is housed within the enclosure 102 and is operable to provide consistent electrical output across a range of environmental conditions, enabling the system 100 to maintain autonomous operation during periods of insufficient solar irradiance or when deployed in locations lacking external power infrastructure.

### Modularity

The system 100 is configured as a modular platform to facilitate varying levels of extraction well 101 interaction. In a first configuration, the system 100 comprises a data acquisition and telemetry station for the real-time monitoring of gas composition, vacuum pressure, and/or thermal data via a temperature probe 114. In a second configuration, the system 100 further comprises a non-invasive valve adjuster 116 for the mechanical regulation of gas flow. In a third configuration, the system 100 is selectively configurable for power via a pivoting solar panel assembly 110 or a hardwired power interface. In a fourth configuration, the system 100 further comprises a calibration module 406 for automated sensor verification. The controller 400 is configured to automatically detect the presence of these modular components and adjust the control logic accordingly. This modular architecture allows the system 100 to be deployed in a variety of functional states without requiring a physical redesign of the controller 400. The systems sampling 106, exhaust 107 and ambient 108 ports are fluidly coupled to the sampling 709, exhaust 712 and ambient 713 ports on the controller. The electrical cable harness 109 for external power and communications is connected to electrical ports on the controller 711 and the battery module 402 inside the enclosure 102.

### Internal Enclosure Details and Security

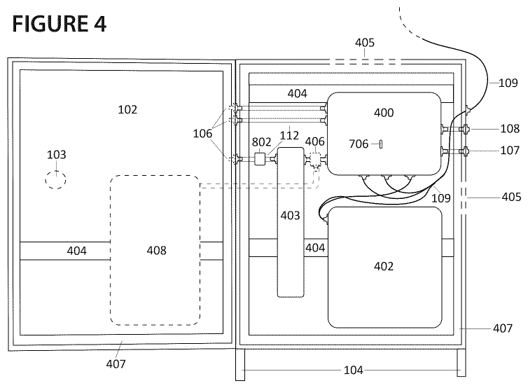

To mitigate the effects of ambient temperature fluctuations, the enclosure 102 may incorporate a thermal management system. As shown in FIG. 4, this system may comprise insulation 407 and strategically positioned venting 405 to facilitate heat dissipation for internal modules. The enclosure 102 is further configured to provide physical shielding against environmental exposure to minimize temperature spikes, sensor drift, and internal condensation. To prevent the ingress of debris or pests, the venting 405 may include a protective mesh or baffle system. Additionally, external tubing 112 and hardware connections at the extraction well 101 ports, including the device selector 117, may be provided with an insulating sleeve 113 to prevent freezing or condensate formation.

Hardware security is managed by a satellite based geofencing sub routine. The controller 400 monitors its geographic coordinates and triggers a theft alert if the assembly is displaced beyond a predefined safety radius without authorization. During such an event, the system transmits real time tracking coordinates to the cloud application 905 to facilitate recovery.

### Intrinsic Safety

To facilitate operational safety in the potentially explosive environments characteristic of landfills, the electronic infrastructure of the assembly is engineered to align with safety standards for hazardous locations. The battery module 402 is disposed within the enclosure 102 as a discrete module to maintain physical separation from the gas path. The battery module 402 is integrated with a charge controller (not shown, typically a printed circuit board attached to the battery) which regulates input from a regenerative power source to maintain stable voltage levels and mitigate the risk of electrical surges within the enclosure 102. This configuration utilizes an energy storage device selected for high thermal stability so that monitoring and control functions remain active during extreme ambient temperature gradients.

To create a multi-layered safety barrier, the controller 400, which houses the gas sensor suite 703 and associated pneumatic valves, is configured as a hermetically sealed module isolated from the battery module 402 and communications 707 modules. This modular isolation is designed to mitigate the risk of inadvertent gas leakage from contacting potential ignition sources within the electronics compartment.

The controller 400 is configured to monitor the internal temperature of the enclosure 102. Any detected thermal anomalies that exceed expected levels are logged as discrete events within the cloud application 905.

### Valve Adjuster

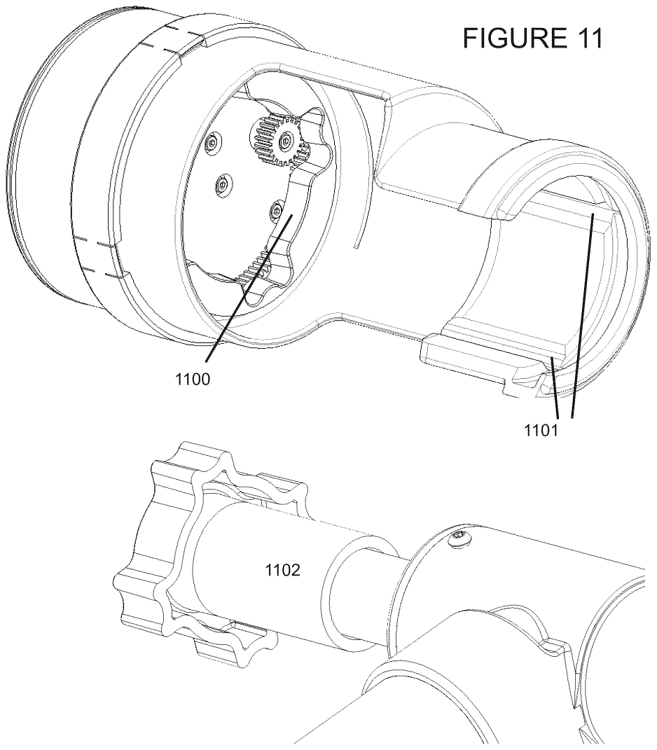

A primary mechanical differentiator of the assembly is the non-invasive valve adjuster 116. Unlike prior art mechanisms that require axial coupling to a valve shaft or the intrusion into gas containment pipes, the non-invasive valve adjuster 116 is configured to engage the existing manual wellhead valve 209 handle. The non-invasive valve adjuster 116 may be designed with a specialized geometry that can be manufactured in various shapes to accommodate different handle dimensions, effectively functioning as a mechanical sleeve. As illustrated in FIG. 11, the specialized geometry may incorporate a guided path 1101 to anchor the rotation of motor such that, as the valve rotates, the motor assembly moves linearly with it, unlike most actuators which remain fixed. Moreover, standard wellhead valves 1102 move in and out during rotation, similar to a screw. In a specific embodiment, the valve adjuster is designed to move in and out with the inward and outward motion of the screw. The non-invasive valve adjuster 116 utilizes a locking mechanism 501 that prevents the assembly from slipping out of place and ensures rotational force is applied uniformly during any adjustments. In a specific embodiment, the valve adjuster sleeves tightly over the valve and uses a locking mechanism to interlock with the handle rotation 1100. This ‘glove design’ can be configured for various different shapes of wellhead valve types. The non-invasive valve adjuster 116 is powered by a motor 500 in operable communication with the controller 400. Upon deployment, a technician initiates a guided calibration routine to determine an operational range of the motor 500 relative to the unique physical characteristics of the manual wellhead valve 209. During this routine, the motor 500 rotates the manual wellhead valve 209 handle to identify physical end stops or designated travel limits. The system monitors amperage draw, torque feedback, and amperage spikes to map the valve position and identify the torque needed while accounting for resistance caused by wear, dirt, or obstructions. This learned data is stored as a baseline profile. By utilizing a partial calibration sequence, the assembly is configured to establish functional parameters while minimizing setup time and limiting disruption to gas flow. Subsequent adjustments use the baseline profile to ensure the motor 500 applies sufficient force to move the handle without exceeding safe limits.

Autonomous wellhead regulation logic is managed via a proportional integral derivative PID based mathematical feedback loop. The proportional component calculates an adjustment based on the current magnitude of the error between measured data and the target setpoint. The integral component accounts for the accumulation of past errors, helping to correct small and persistent deviations to bring the wellhead back to the target state.

The derivative component serves as a predictive tool, calculating the rate of change in the wellhead data to dampen the adjustment speed. This dampening prevents the valve adjuster from overadjusting too aggressively in response to sudden fluctuations. By modulating the rate of change, the system reduces overshoot relative to the target setpoint, which helps mitigate pneumatic shocks and dampens pressure spikes within the collection circuit. This provides a method for gas levels to be adjusted smoothly to maintain a stable extraction profile without inducing rapid shifts in gas chemistry.

The PID mathematical feedback loop is executed via a cloud application 905 that maintains the wellhead in a state of controlled modulation by processing these three distinct mathematical components to calculate valve adjuster 116 movements of the valve 209 in incremental steps to reach expected levels. By housing the control logic in the same cloud based environment as the system data, the application can analyze historical trends and data from adjacent wellheads to anticipate necessary adjustments and refine the feedback loop.

As a default operating state, the system operates to facilitate safety and regulatory compliance by maintaining parameters within defined thresholds, such as maintaining negative pressure and maintaining oxygen concentration below a target percentage, such as 5%. The system further allows users to select from a plurality of optimization profiles, which are not limited to any specific configuration. For example, a Renewable Energy Quality mode may be selected to prioritize a combination of gas flow quantity and methane concentration to optimize fuel delivered to downstream energy recovery assets.

To facilitate accurate data and reach expected levels during adjustments, the system utilizes passive transducers to derive volumetric flow and vacuum pressure. The logic incorporates a settling time constant within a move-wait-measure cycle. After each movement by the non-invasive valve adjuster 116, the controller 400 initiates a stabilization phase, pausing for a specific period to allow the physical gas flow, negative pressure, and chemical composition to stabilize across the pneumatic path before the sensors acquire the next data set.

If an undesired condition or a threshold exceeding event is detected, such as an increase in oxygen ingress, the controller 400 is configured to transition from a standard monitoring state into a high frequency sampling mode. In this mode, the system operates at an increased sample rate with discrete intervals.

Upon entering this mode, the assembly executes an incremental adjustment to the valve position. The controller 400 then initiates a dwell period to allow the gas characteristics within the collection line to stabilize and catch up to the mechanical change. At the conclusion of this discrete interval, the system resamples the gas. This helps that the new sample reflects the impact of the previous adjustment before the controller 400 determines the next incremental step. This iterative process allows the system to gauge the correction accurately and promote field stability.

During this high frequency sampling mode, the controller 400 transmits real-time data to a cloud application 905. This application implements neighbor-aware tuning logic by evaluating the data from the controller 400 in the context of data received from neighboring units across the site. By considering these neighbor-aware factors, the application distinguishes between localized well conditions and site-wide atmospheric events before transmitting a command back to the controller 400. If the application identifies a barometric event, it coordinates synchronized PID setpoint adjustments across multiple valve adjusters. This centralized coordination provides a method for adjustments at a specific wellhead to avoid adversely impacting the radius of influence of adjacent extraction wells 101, thereby maintaining the stability and collection efficiency of the entire gas collection and control system 204.

To facilitate regulatory compliance and auditing, every command and adjustment determined by the cloud application 905 is logged as a discrete event. This provides a data trail for each valve adjuster within the network, allowing operators to record and report automated adjustments in terms of regulatory requirements.

The control logic employs a weighted priority architecture to resolve conflicting sensor signals during autonomous regulation. When multiple characteristics deviate from their respective setpoints simultaneously, the PID algorithm prioritizes corrective actions based on a hierarchy of safety, compliance, and finally, quality. For example, if the oxygen concentration deviates toward a safety limit, or if the static pressure indicates a transition toward positive pressure, the controller 400 increases the weighted priority of those signals. This allows the PID loop to preemptively throttle flow through incremental valve adjuster movements to promote regulatory compliance before safety limits are approached. Once safety and compliance metrics are stabilized, the logic shifts weighted priority toward gas quality optimization, utilizing methane concentrations and flow rate data to calculate adjustments that maximize the energy content of the extracted gas.

The system remains in operable communication with the cloud application 905 to facilitate external commands and manual overrides. This architecture allows an operator to remotely adjust the valve adjuster position or modify target setpoints for pressure or gas concentration. When a manual position command is received, the controller 400 temporarily suspends the autonomous mathematical loop to execute the user defined adjustment, after which the controller 400 resumes PID based regulation based on the updated position or modified setpoints.

### Gas Pathway and Conditioning

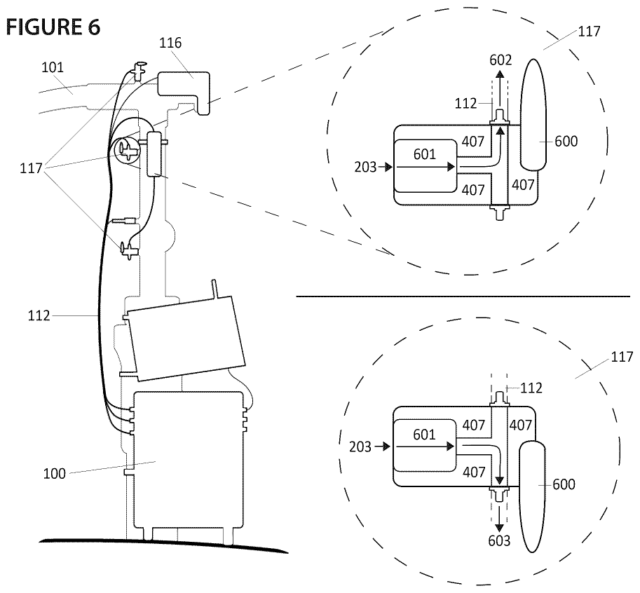

With reference to FIG. 6, the pneumatic path for gas sampling and conditioning is separate from the primary wellhead flow and is designed to pull a discrete gas sample away from the extraction well 101 and into the enclosure 102 for high resolution analysis. The gas sample is drawn through a port adapter 601 of a device selector 117, which is configured to allow an operator to choose between automated monitoring and manual sampling. Tubing 112 is optionally encased in an insulating sleeve 113 to prevent freezing during transit to the enclosure 102.

The assembly incorporates a hardware-based device selector 117 specifically configured to facilitate wellhead routine compliance sampling. This hardware selector comprises a mechanical diverter 600 that allows a user to selectively route the gas sample path between the internal sensing module and an external sampling port. In a primary operational state, the device selector 117 directs the gas flow through tubing 112 to the internal sensors for autonomous monitoring. In a secondary state, the device selector 117 diverts the gas flow to the external sampling port 603, enabling the direct connection of a handheld analyzer (not shown). This configuration allows an operator to perform independent regulatory checks or compare system data against secondary equipment without requiring the disassembly of the primary pneumatic pathway.

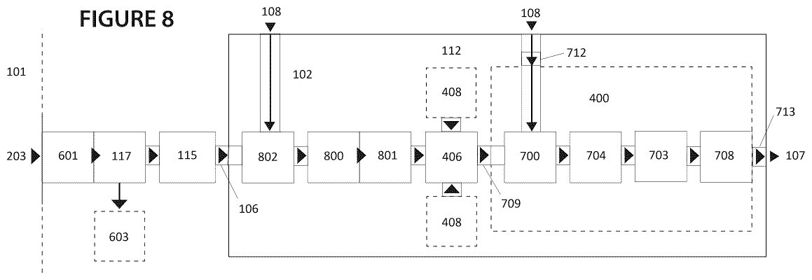

With reference to FIGS. 6 and 8, when the device selector 117 is set to automated monitoring, a pump 708 pulls the gas sample through a multi-stage physical conditioning assembly comprising tubing 112, filtration 115, device selector 117, port adapter 601, hydrophobic filter 800, desiccant 801, and pressure relief valve 802. This assembly involves a variety of filtration 115 methods including, but not limited to, water trap and a particulate filter, which may be replaceable and are configured to be secured to the extraction well 101. The conditioning assembly is positioned at an elevation above the well sampling port 208 to facilitate gravity-assisted drainage. The controller 400 is configured to actuate this pressure relief valve 802, when present, to facilitate a self-clearing cycle. During this cycle, internal pressure is released, allowing collected condensate to flow backward through the tubing 112, through the device selector 117, and through the port adapter 601 to return to the well sampling port 208. This utilizes gravity and pressure differentials to maintain line integrity without manual intervention, specifically in landfill gas 203 environments characterized by high moisture content and corrosive or particulate-heavy compositions.

Downstream of the external filtration 115, the gas sample enters the enclosure 102 and passes through a hydrophobic filter 800. This hydrophobic filter 800 is positioned prior to a desiccant 801 to remove fine liquid droplets. The desiccant 801 container utilizes a clear housing and a modular coupling, such as a twist off or bayonet style mechanism, for rapid replacement. The media within the desiccant 801 container may include color changing chemical indicators to visually signal saturation levels. This allows a technician to gauge the need for maintenance immediately upon opening the enclosure 102. The desiccant 801 media is specifically selected to remove residual moisture and, optionally, hydrogen sulfide, from the gas sample stream before the sample reaches the gas sensor suite 703.

Following the multistage conditioning assembly, the gas sample is introduced into a gas sensor suite 703 housed within the controller 400. The gas sensor suite 703 comprises a plurality of transducers configured for the high resolution acquisition of gas specific characteristics. In at least one embodiment, the gas sensor suite 703 is configured to measure methane, carbon dioxide, and oxygen concentrations. The gas sensor suite 703 is further modular, allowing for the optional integration of additional sensors configured for the detection of hydrogen sulfide or other gas constituents. These sensors are in operable communication with the controller 400. The controller 400 is configured to receive and process both raw analog transducer signals and pre-processed digital signals, with the capability to adjust input polarity to accommodate various sensor configurations. The controller 400 then converts or aggregates this data into a digital format representing the chemical composition of the extracted gas for transmission to the cloud application 905, which is configured to apply calibration, convert the signals into usable data, and calculate the remaining gas concentration based on the measured primary gas constituents. Other sampling ports 709 are used for measuring pressure differentials at other well head sampling ports 208. A pressure selection valve 701 is used to switch the differential sources.

### Ambient Purge

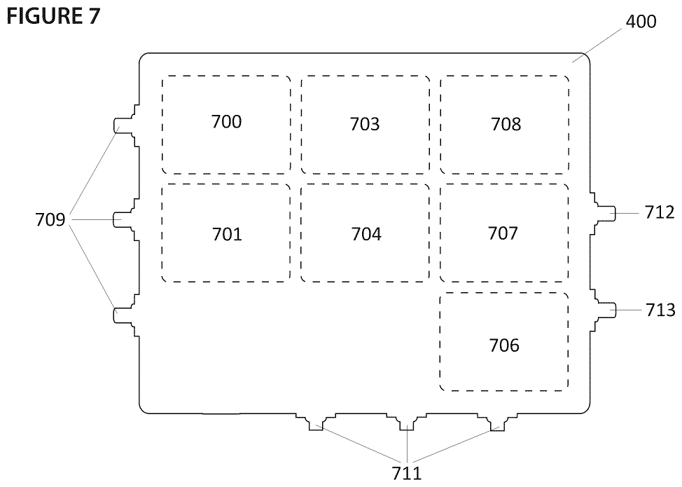

The controller assembly is shown in FIG. 7 and includes a sample selection valve 700 configured to selectively switch a sample intake from a wellhead gas stream to ambient atmospheric air. This ambient intake is utilized for purging the gas sensor array 703 to facilitate sensor longevity. The controller 400 is configured to automatically execute a purge routine following the completion of a sampling session. A pump 708 drives the ambient air through the gas sensor suite 703 to remove residual moisture and corrosive gases, promoting a protective isolation state for the transducers between active sampling events.

### Calibration Module

The controller assembly optionally includes a calibration module 406 configured to execute automated or manually triggered recalibration routines. The calibration module 406 comprises calibration selection valves configured to select between one or more pressurized containers of calibration gas 408 or the sample. These gases include zero or span gases for methane, carbon dioxide, oxygen, or other constituents.

The gas sensor suite 703 is modular, allowing additional or alternative transducers to be integrated into the pneumatic path without requiring a physical redesign of the controller 400 housing. By integrating the sensors within the controller 400, the transducers are shielded from environmental degradation while shortened electrical paths minimize signal interference. After the sampling session is complete, the gas sample is exhausted from the system through the exhaust port 107.

The controller 400 is configured to transmit digital data to a cloud application 905 via a communications 707 interface. The calculation of gas concentrations, including the remaining balance gas, is performed within the cloud application 905. The cloud application 905 is configured to transmit control instructions back to the controller 400 for managing the autonomous adjustment of the extraction well 101 via a motor 500.

### Sampling Triggers

To facilitate real time monitoring of the wellhead conditions, the controller assembly incorporates passive transducers including but not limited to one or more pressure sensor(s) 704 and input from temperature probe 114. These sensors operate continuously to establish the baseline physical state of the gas flow at the extraction well 101 interface. The controller 400 utilizes data from these sensors to identify fluctuations in the physical environment. Because these sensors 704 and 114 are always active in a low power monitoring state, they provide a constant stream of data regarding the vacuum and pressure levels of the extraction well 101.

### Logic and Autonomous Control

The controller assembly employs a multi-trigger logic architecture to initiate a full gas sampling sequence through the conditioning assembly and gas sensor(s) 703. In a primary trigger mode, the controller 400 executes sampling cycles at user defined time intervals to establish a periodic baseline. In a secondary, passive sampling mode, the system utilizes the continuous data from the passive transducers to identify a meaningful change in wellhead conditions, such as a sudden fluctuation in vacuum pressure or temperature. In a tertiary trigger mode, the system allows an operator to manually initiate a sampling sequence via the cloud application 905 or a local interface.

Upon the detection of an anomaly by the passive transducers, or upon a manual or scheduled command, the controller 400 initiates an active sampling sequence. If an anomaly is detected, the controller 400 is further configured to transition from the monitoring state into a high frequency sampling mode. In this high frequency mode, the sampling interval is increased to a discrete period, such as every 15 minutes, to provide additional data as the non-invasive valve adjuster 116 works to correct the event.

Furthermore, the controller 400 is configured to execute neighbor-aware tuning logic. When a high-frequency sampling mode is triggered at a specific node, the controller 400 communicates the event to the cloud application 905, which evaluates the status of neighboring extraction wells 101. The cloud application 905 is then configured to transmit commands to neighboring nodes to coordinate vacuum levels, ensuring that an adjustment at one well does not pull gas away from or destabilize the collection area of an adjacent well. By coordinating these adjustments, the system distinguishes between localized well events and site-wide atmospheric or vacuum changes, allowing corrective actions to be applied across the relevant portion of the wellfield to stabilize the collection system.

### Communication and Data Management

Communication is managed through a multi protocol interface housed within the controller 400 and utilizes external antennas 111. The assembly utilizes a mesh network protocol to establish a communication mesh between neighboring units. In this configuration, any monitor may be configured as a signal routing node or an internet gateway to identify paths to a cloud based uplink. An incoming packet 903 can be either passed onto another device in the mesh 904, or sent to the cloud 905 if available 902. This allows units that lack a local cellular connection or encounter signal interference to transmit data to the cloud application 905 via a neighboring gateway node.

The system is configured to incorporate local meteorological data retrieved from an internet based source or an on site device into the sampling or adjustment logic. The cloud application 905 utilizes this data, alongside the data transmitted across the mesh network, to execute neighbor aware tuning logic. By analyzing simultaneous data sets from adjacent units and local environmental conditions, the application distinguishes between localized well events and site wide atmospheric changes.

If the cloud application 905 identifies a trend requiring a field wide adjustment, it transmits updated setpoints or commands back to the individual controllers 400. The controllers 400 then adjust their respective valve positions to promote field wide stability. When high frequency sampling is triggered at a specific node, neighboring nodes may simultaneously adjust sampling frequencies or respective valve adjusters to facilitate a balanced gas extraction profile.

To prevent data loss during communication outages, the controller 400 includes a local nonvolatile memory module. This hardware logs and buffers sensor data locally. Once a network connection is re-established, the controller 400 executes a batch upload of the stored data to the cloud application 905 to maintain a complete historical record.

### Software and Compliance

To facilitate field management, the application incorporates a multiuser portal with granular permissions. This portal allows for the assignment of various roles, such as Field Technician, Regulatory Compliance Officer, and Administrator via admin pages 1000, each with specific access to data visualization and reporting tools. To assess aggregate landfill health and operational efficiency, the sample all tool 1002 allows an operator to trigger a simultaneous sampling event across every networked wellhead in the system.

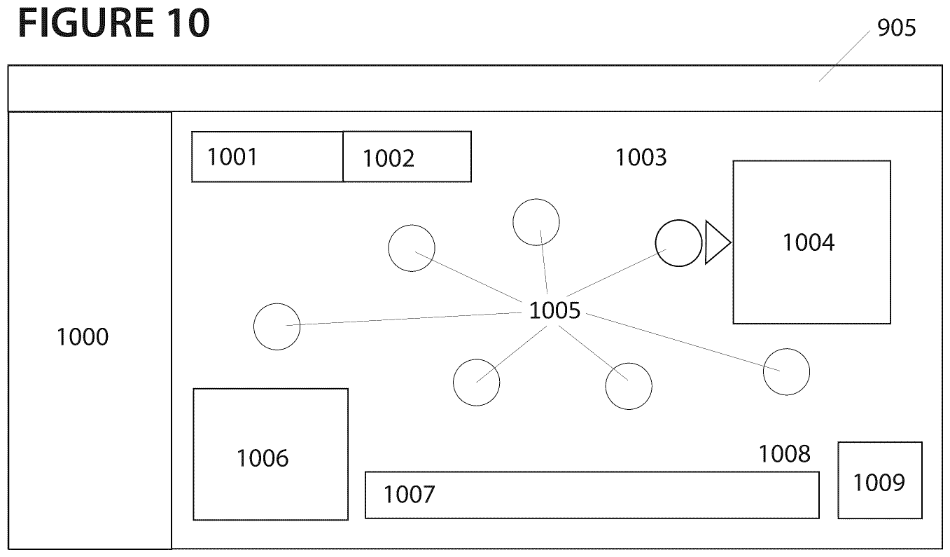

As illustrated in FIG. 10, the cloud application 905 presents a user interface for site-wide monitoring and control. The interface displays a specific site name 1001 and a graphical site map 1003 populated with individual wellheads. Interaction with a wellhead on the map populates a wellhead details 1004 pane, which provides a specific wellhead number and status 1005. To provide environmental context for gas fluctuations, the interface includes a current weather 1006 module and a synchronized date and time 1008 stamp. Users can perform historical analysis via a time scrubber tool 1007 to review past wellfield states, while a suite of view tools 1009 provides navigation functions, such as zooming in and zooming out, to adjust the scale of the site map 1003.

### ALTERNATIVE EMBODIMENTS

The embodiments described herein for landfill gas extraction are exemplary. It is understood that the specific dimensions, materials, and configurations of the valve adjuster 116 and the associated sensing manifold may be modified to accommodate various sizes and types of manual valves. The invention specifically contemplates variations in the mounting hardware and drive engagement to ensure compatibility with different legacy valve handle geometries found within a wellfield.

It will be appreciated by those skilled in the art that changes could be made to the exemplary embodiments described above without departing from the broad inventive concept thereof. It is understood, therefore, that this invention is not limited to the exemplary embodiments shown, but it is intended to cover modifications within the spirit and scope of the present invention as defined by the claims. For example, specific features of the disclosed embodiments may be combined or omitted. Unless specifically set forth herein, the terms “a”, “an” and “the” are not limited to one element but instead should be read as meaning “at least one”.

To the extent that any methods described do not rely on the particular order of steps set forth herein, the particular order of the steps should not be construed as a limitation on the claims. The claims directed to the methods of the present invention should not be limited to the performance of their steps in the order written, and one skilled in the art can readily appreciate that the steps may be varied and still remain within the spirit and scope of the present invention.

What is claimed is:

1. A gas wellhead monitoring and control device, comprising:
a valve adjuster configured to non-invasively engage a handle of a wellhead valve extracting landfill gas;
a controller in operable communication with at least one sensor and the valve adjuster,
wherein the controller directs the valve adjuster to move the handle of the wellhead valve in response to input from the sensor so as to adjust a flow rate of landfill gas through the wellhead valve.

2. The device of claim 1, wherein the valve adjuster comprises a rotary drive member and an electric motor that rotates the rotary drive member so as to adjust the handle.

3. The device of claim 2, wherein the valve adjuster further comprises a conforming interface to accommodate varying handle geometries.

4. The device of claim 1, wherein the system is installed and fully operational without cessation of vacuum pressure or gas flow and/or without cutting or modifying structures of the wellhead.

5. The device of claim 1, wherein the sensor measures pressure, temperature, and/or a gas characteristic.

6. The device of claim 1, wherein the controller identifies rotational limits of the manual wellhead valve handle by monitoring a feedback signal from the valve adjuster.

7. The device of claim 1, further comprising a plurality of sensors configured for continuous monitoring of wellhead pressure and temperature.

8. The device of claim 7, wherein the controller initiates a gas sampling sequence in response to an event above or below the threshold detected by the sensors.

9. The device of claim 1, further comprising a device selector comprising a multi-port mechanical diversion interface configured to selectively route gas between the sensor and an external sampling port.

10. The device of claim 1, wherein the controller is configured to transition from a monitoring state into a sampling mode upon detection of a deviation in gas characteristics.

11. The device of claim 1, wherein the cabinet further comprises adjustable support members configured to level the cabinet on an uneven surface.

12. The device of claim 1, wherein the controller is capable of being remotely controlled.

13. The device of claim 1, wherein the valve adjuster further comprises a locking mechanism for securing the valve adjuster to the wellhead.

14. The device of claim 1, wherein the handle and valve rotate and move inward and outward as the valve is rotated, and wherein the valve adjuster is configured to move inward and outward with the handle and/or valve.

15. A autonomous landfill gas management system, comprising:
a plurality of nodes wherein each node comprises a device of claim 1, wherein each device controller comprises a communication device that is in operable communication with a remote application and wherein the remote application is configured to normalize localized sensor data of one device against sensor data of another device and monitor and/or demand autonomous adjustments to each device.

16. The system of claim 15, wherein each node includes a local non-volatile storage device configured to buffer sensor data during communication outages.

17. The system of claim 15, wherein the remote application includes a mathematical feedback loop that incorporates a stabilization time constant to ensure stabilization of well conditions during continuous valve modulation.

18. The system of claim 15, wherein the remote application instructs at least one device controller to engage the valve adjuster of the device and upon such instructions the controller engages the valve adjuster moving the handle and adjusting the flow rate of landfill gas being extracted by a particular device.

19. The system of claim 15, wherein each node is configured to autonomously route data packets through a local mesh network to an internet gateway if a direct connection is obstructed.

20. A method for controlling extraction of landfill gas from a landfill using a landfill gas control device, wherein the device comprises a controller in operable communication with at least one sensor fluidly engaged with landfill gas output from a well and a valve adjuster, the valve adjuster configured to engage a handle of a wellhead valve, the method comprising:
obtaining from a sensor, at the gas output, a measure of at least one of temperature, pressure, a gas characteristic or combinations thereof from the landfill gas;
determining whether the measure of the temperature, pressure, gas characteristic or combinations thereof from the landfill gas collected from is outside of a predetermined range;
when it is determined that the measure of the temperature, pressure, gas characteristic or combinations thereof from the landfill gas collected from is outside of a predetermined range, and adjusting the well head valve via the valve adjuster.

21. (canceled)

22. (canceled)

23. (canceled)

24. (canceled)
